(19) United States
(12) Patent Application Publication
(10) Pub. No.: US 2026/0332560 A1
(43) Pub. Date: Oct. 22, 2026

(54) REDACTION SYSTEM AND METHOD

(71) Applicant: Kainos Worksmart Limited, Belfast (GB)

(72) Inventors: Damien TAYLOR, Belfast (GB); Brian NOBLE, Belfast (GB); Andrew STEWART, Belfast (GB)

(73) Assignee: Kainos Worksmart Limited, Belfast (GB)

(21) Appl. No.: 19/099,397

(22) PCT Filed: Jul. 18, 2023
(86) PCT No.: PCT/EP2023/069971

§ 371 Date: Jan. 28, 2025

(30) Foreign Application Priority Data
Jul. 28, 2022 (GB) 2211003.5

(51) Int. Cl. H04L 9/40

(52) U.S. Cl. CPC H04L 63/0245; H04L 63/0263

(57) ABSTRACT

A method of redacting server responses in a client-server computing system in which a server and a client communicate via a gateway comprises: receiving, at the gateway, a response from the server; identifying redaction rules for use in redacting the response; selectively redacting the response content in accordance with the redaction rules; and sending a corresponding redacted response to the client. The response content includes content identifiers, respective redaction rules being associated with respective content identifiers in order to determine how respective parts of the content are redacted. The redaction rules may be configured differently for each user of the system. The method enables users to access resources on the server while allowing control over how the server response content is rendered to each user.

### FIELD OF THE INVENTION

This invention relates to the protection of information in computer systems. The invention relates particularly, but not exclusively, to the protection of information in multi-tenancy Software as a service (Saas) computer systems.

### BACKGROUND TO THE INVENTION

Organizations using cloud-based SaaS platforms such as Workday (trade mark) find it necessary to provide users with elevated access to non-production and production tenants to perform tasks such as configuration, security administration, testing and training. This elevated access often allows users access to highly sensitive data areas also.

Non-production SaaS environments often contain recent copies of production data meaning non-production environments can contain accurate and up-to-date information including personally identifiable information (PII), sensitive personal information (SPI), financial data, customer data and/or other sensitive data.

Typically, authorisation of data access is managed in the SaaS platform using security group configuration(s). For example users with access to a particular security group access can access information and perform transactions in relation to data associated with the particular security group, while all other users are prevented from viewing this data set and performing tasks in relation to same. Security group configuration allows organizations granular control of who can view data and perform tasks. This is used to ensure that users can only see and do what they need to in the production environment.

However, there are a number of scenarios, including those listed below, in which it is desirable to provide a user with elevated access to security group(s), but also prevent the user from viewing some or all of the data members of that security group would normally have access to, particularly in non-production tenants.

In addition, to facilitate such scenarios SaaS platforms often support configuration to allow users in non-production environments to act on behalf of another user. Users of non-production tenants are often granted the ability to act on behalf of other users to perform tasks e.g. approvals. However, when a user is acting on behalf of another user they can also see all the data that other user could see.

Examples of scenarios that may require a user to be given elevated security access are provided below.

Configuration changes: Members of configuration or implementation teams require elevated access to make and test configuration changes within the SaaS platform. In this scenario, the users only need to see a limited set of fields on a limited set of records, without needing to see the data for a wider set of the population.

Staff training exercises: When performing staff training it is desirable for the trainer to allow trainees to get ‘eyes-on’ or ‘hands-on’ experience of the actual functionality configured in SaaS platform without being able to see all sensitive data such as D&I data

User guide writers: During the process of deploying new functionality and configuration, process authors typically use screenshots to inform their training materials. It is useful to have a centrally controlled redaction of the fields before a screenshot is taken to help prevent radiation omission errors going into printed training materials.

Company merger: During a merger of two or more companies it is typical to merge software platforms. Members of similar groups from each company can find they now have access to information from each other's company. There can be a period during a merger process where it is desirable to provide access to the new software but to redact the information of users from one company to the other.

Conventionally, protecting information in scenarios such as those outlined above is performed by managing security configurations and/or by data scrambling. However, security configuration is primarily for production environments, e.g. determining what users can see as part of business as usual (BAU) operations. Additional security configuration can be applied for non-production environments, but it makes the security configuration very complex and therefore more fragile. Also, in cases where users obtain elevated security permissions to act on behalf of another user, they normally have access to information that they do not need to see. Data scrambling involves modifying data at storage level using an irreversible process. This renders the data less useful for testing and training as the data no longer matches real world data. Data scrambling can often be a slow process, which is problematic for platforms that are regularly updated with a fresh copy of data from the production environment. Also, the data is scrambled for all users of the tenant, meaning different views of the data cannot be provided for different uses.

It would be desirable to mitigate at least some of the problems outlined above.

### SUMMARY OF THE INVENTION

From one aspect the invention provides a method of redacting server responses in a client-server computing system in which a server and a client communicate via a gateway, the method comprising: receiving, at said gateway, a response from said server, wherein said response includes content associated with at least one content identifier; identifying at least one redaction rule for use in redacting said response, wherein at least one of said at least one redaction rule is associated with at least one of said at least one content identifier; selectively redacting at least part of said content in accordance with the, or each, identified redaction rule associated with the, or each, content identifier; sending a corresponding response to said client, said corresponding response comprising the redacted content.

From another aspect the invention provides a method of redacting server responses in a client-server computing system in which a server and a client communicate via a gateway, the method comprising: receiving, at the gateway, a response from the server; identifying one or more redaction rules for use in redacting the response; selectively redacting the response content in accordance with the redaction rule(s); and sending a corresponding redacted response to the client. The response content typically includes one or more content identifier, respective redaction rule(s) being associated with respective content identifier(s) in order to determine how respective parts (e.g. element(s) or content item(s)) of the content are redacted. Alternatively or in addition the response includes or is associated with a user identifier identifying a user of said client and/or other user of the system (e.g. an employee or other person in respect of whom data may be included in the response content), and/or one or more user-related identifier identifying a respective attribute of the respective user(s), respective redaction rule(s) being associated with respective user identifier and/or one or more user-related identifier in order to determine how respective parts (e.g. element(s) or content item(s)) of the content are redacted. The redaction rules may be configured differently for each user of the system. The preferred method enables users to access resources on the server while allowing control over how the server response content is rendered to each user.

In preferred embodiments, said content comprises at least one content element, and said at least one content identifier comprises at least one content element identifier, wherein at least one of said at least one content element identifier is associated with at least one of said at least one redaction rule, said redacting involving redacting one or more of said at least one content element in accordance with the, or each, redaction rule associated with the, or each, respective content element identifier, the, or each, respective content element identifier typically also being associated with said one or more of said at least one content element, and wherein said corresponding response comprises the one or more redacted content element.

Preferably, said at least one content element identifier comprises at least one unique content element identifier that uniquely identifies the respective content element, and wherein the, or each, respective redaction rule indicates if said respective content element is to be redacted and/or how said respective content element is to be redacted.

Optionally, said at least one content element identifier comprises at least one data type identifier that identifies a type of data contained in the respective content element, and wherein said redacting involves redacting the respective content element depending on the type of data identified by the, or each, respective data type identifier.

Typically, said at least one content identifier is included in, or associated with, said content, wherein said identifying at least one redaction rule involves identifying said at least one redaction rule depending on said at least one content identifier.

Said response may include or be associated with one or more user identifier identifying a user of said client and/or one or more user in respect of which the content relates, and/or one or more user-related identifier identifying a respective attribute of said the, or each, user. Said one or more user-related identifiers may comprise any one or more of: a unique identifier of the user; an identifier of an organisation or group with which the user is associated; an identifier of the type of user; an identifier of a security access level of the user; an identifier of a geographical location of the user, or an identifier of any other attribute relating to the user.

The method may include obtaining said user identifier and/or said one or more user-related identifier from said response, or from a request sent by said client to said gateway, or from said client, or from said server.

The user identifier and/or said one or more user-related identifier may be associated with a session, for example a login session, established between the client and the server via the gateway.

The method may include obtaining said user identifier and/or said one or more user-related identifier from one or more aspect of said session, wherein said one or more aspect may comprise any one or more of: one or more server-side cookie; one or more client-side cookie, a session ID, a request URL and/or from overhead associated with the response, the session and/or a request sent by said client to said gateway.

Identifying at least one redaction rule may involve identifying said at least one redaction rule depending on said user identifier and/or said one or more user-related identifier.

Said content may include one or more respective part or respective element(s) relating to a plurality of users, and wherein the respective part or element is redacted depending on the respective user-related identifier(s) and/or respective redaction rule set(s) associated with the respective user, and wherein each user may be a person, e.g. an employee.

Typically, said redacting involves removing said at least part of said content, or replacing said at least part of said content with alternative content.

Optionally, said redacting involves removing the respective content element from the response content.

Typically, said at least one content element comprises data, wherein said redacting may involve deleting said data or replacing said data with alternative data, wherein said alternative data is preferably of the same type as the replaced data.

Optionally, said at least one content element comprises a link to a resource, a unique resource identifier and/or a unique resource locator (e.g. a resource, a unique resource identifier and/or a unique resource locator provided by the server), and wherein said redacting involves removing said link, said unique resource identifier and/or said unique resource locator.

Optionally, said at least one content element comprises a link to a resource, a unique resource identifier and/or a unique resource locator that identifies or otherwise relates to said server, the method further including modifying or replacing said link, said unique resource identifier and/or said unique resource locator to identify or otherwise relate to said gateway.

Optionally, said identifying involves identifying at least one default redaction rule for use in redacting said response.

Optionally, said identifying involves, in response to failing to identify at least one redaction rule associated with said response or said content, using at least one default redaction rule to redact said response or content.

Optionally, said identifying involves, in response to failing to identify at least one redaction rule for at least one of said at least one element identifier, using at least one default redaction rule to redact said at least one of said at least one element identifier.

Optionally, said identifying involves, in response to failing to identify said at least one redaction rule depending on said user identifier and/or said one or more user-related identifier, using at least one default redaction rule to redact said response or content.

Optionally, said at least one redaction rule comprises at least one redaction rule that is not associated with said at least one content identifier, and wherein said method includes, in respect of at least one redaction rule that is not associated with said at least one content identifier, obtaining from said server information relating to at least one redaction rule that is not associated with said at least one content identifier, and, depending on said information received from said server, selectively redacting at least part of said response or at least part of said content in accordance with said at least one redaction rule that is not associated with said at least one content identifier.

Optionally, said at least one redaction rule comprises at least one redaction rule that is associated with an attribute of said content, and wherein said method includes, in respect of at least one redaction rule that is associated with said attribute, obtaining from said server information relating to said attribute, and, depending on said information received from said server, selectively redacting at least part of said response or at least part of said content in accordance with said at least one redaction rule associated with said attribute.

Typically, said response relates to a request sent by said client to said gateway, the method including, receiving sad request at said gateway, forwarding said request from said gateway to said server, and receiving said response at said gateway.

Optionally, said content comprises at least one content item, each content item comprising at least one content element, wherein said at least one content identifier comprises at least one content item identifier, wherein at least one of said at least one content item identifier is associated with at least one of said at least one redaction rule, said redacting involving redacting one or more of said at least one content item in accordance with the, or each, redaction rule associated with the, or each, respective content item identifier, the, or each, respective content item identifier typically also being associated with said one or more of said at least one content item, and wherein said corresponding response comprises the one or more redacted content item.

Optionally, one or more of said at least one content item relates to a respective person, and wherein the or each respective redaction rule for the respective content item may be determined by or associated with one or more attribute associated with the respective person and/or one or more user identifier or user-related identifier associated with the respective person, and wherein the or each attribute may be any one or more of: an organisation or group with which the person is associated; the type of person; a security access level of the person; a geographical location of the person.

The method may include rendering a web page or other user interface at said client, said web page or other user interface including said redacted content. The method may include receiving at said client input data in respect of a redacted part of said redacted content, and communicating said input data to said server. Optionally, said web page or other user interface comprises one or more element that is redacted, the method including receiving input data at said client in respect of at least one redacted element, and communicating the input data to said server.

From another aspect, the invention provides a client-server computing system comprising a server, at least one client and a gateway, said server and said at least one client being in communication with each other via said gateway, the gateway being configured to receive, a response from said server relating to a request from any one of said at least at least one client, wherein said response includes content associated with at least one content identifier, the gateway being configured to identify at least one redaction rule for use in redacting said response, wherein at least one of said at least one redaction rule is associated with at least one of said at least one content identifier; the gateway being configured to selectively redact at least part of said content in accordance with the, or each, identified redaction rule associated with the, or each, content identifier; the gateway being configured to send a corresponding response to the requesting client, said corresponding response comprising the redacted content.

Said gateway may be configured to perform, and/or may comprise means for performing, any of the features of the method of the invention.

In preferred embodiments, the gateway system intercepts, or handles, communication between a SaaS client (typically comprising a web browser) and the SaaS platform server. The preferred gateway system is configured to manipulate the payload provided to the web browser from the server to perform redaction of any fields or elements of the payload as required. Typically, this involves parsing and manipulating the response (which typically comprises a data structure or computer file, e.g. in JSON, HTML, XML or other suitable file format or data structure, that contains digital content requested by the client) being returned from the SaaS platform to the web browser. In typical embodiments, the response is an http response. The preferred gateway system is configured to analyse the response to determine if any fields or elements in the response need to be redacted. If any fields or elements do need to be redacted, the gateway system is configured to manipulate, or modify, the response accordingly before sending it to the web browser. The gateway system may manipulate the response to remove, replace, mask or otherwise redact data, and/or to prevent downloading of artifacts, elements or other digital content, especially those that may contain sensitive information. Typically, any or all aspects of the response that are not modified by the gateway system are provided to the client in the original unmodified form. Advantageously, the arrangement is such that, aside from the redacted part(s) of the payload, the user experience is the same as if the gateway system was not present.

Preferred embodiments of the gateway system support any one or more of the following features, which address at least some of the problems associated with conventional approaches to data protection: the ability to redact any element of the response or payload; configuration of which element(s) are to be redacted can be performed on a per-element basis and/or on a per-user basis, and may be independent of any other security configurations; different payload elements, or different types of payload element can be redacted in different ways, for example by removal, replacement or masking; it is possible to apply redaction to the data elements belonging to members of a target population only. e.g. to redact all sensitive data for European residents; the redaction is only implemented in respect of content rendered to the user, i.e. by the web browser in preferred embodiments, and therefore the stored data is not scrambled or otherwise affected at the data layer or storage level (which facilitates applying different redaction for different users); configuring redaction for a particular user can be performed relatively quickly, e.g. in as little as 1 minute; real-time changes to a particular user's redaction configuration can be performed relatively quickly (typically in the order of seconds) and can take effect immediately; the reaction configuration for a given user may continue to be applied even if the user is acting on behalf on another user.

Further advantageous aspects of the invention will be apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a schematic representation of a computer-implemented redaction system embodying one aspect of the invention;

FIG. 2 is a block diagram further illustrating the redaction system of FIG. 1;

FIG. 3A illustrates an example of un-redacted content of a response that may be provided during the operation of the system of FIG. 1;

FIG. 3B illustrates a redacted version of the content of FIG. 3A; and

FIG. 3C illustrates an example of the content of a response containing multiple content items.

### DETAILED DESCRIPTION OF THE DRAWINGS

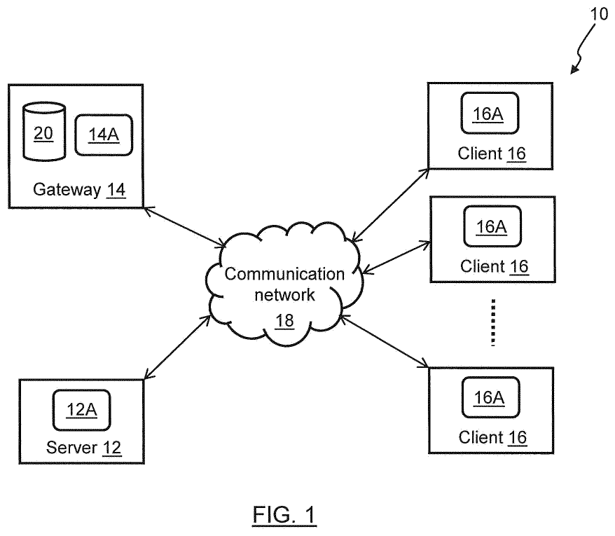

Referring now to FIG. 1 of the drawings there is shown, generally indicated as 10, a computer-implemented redaction system embodying one aspect of the invention. The redaction system 10 comprises a server computing system 12, a gateway computing system 14, and at least one, but typically a plurality of, client computing systems 16. The systems 12, 14, 16 are configured for communication with each other, as required, via a telecommunications network 18. The telecommunications network 18 may take any suitable conventional form, typically comprising a global computer network, in particular the internet. As such, each system 12, 14, 16 may include any conventional hardware, software and/or other means to enable it to communicate via the telecommunications network 18, as would be apparent to a skilled person.

The server computing system 12 typically comprises one or more computer executing, in use, one or more computer program, typically comprising one or more server (software) application or process 12A, and is configured to provide computer-related services to the client computing systems 16 via the network 18. The computer-related services may include provision of data and/or other resources (e.g. provision of downloadable computer program(s) and/or provision of data processing). Data is typically provided in one or more computer file, which may take any suitable conventional file format, e.g. JSON, XML or HTML. In preferred embodiments, the server computing system 12 is a web server. The server application 12A typically comprises a web application. In preferred embodiments, the server computing system 12 is configured to provide Software as a service (Saas) services to the client computing systems 16. As such, the server computing system 12 and/or the server application(s) 12A may be referred to as a SaaS server. The hardware and software components of the server computing system 12, and their configuration, may take any suitable conventional form. In preferred embodiments, the server computing system 12 is a cloud computing system and the network 18 may be referred to as a cloud computing network.

Each client computing system 16 typically comprises one or more computer executing, in use, one or more computer program, typically comprising one or more client (software) application or process 16A, and is configured to request and be provided with the computer-related services from the server computing system 12 via the network 18. In preferred embodiments, each client computing system 16, in particular the client application(s) 16A, comprises a web client, typically comprising a web browser. In preferred embodiments in which the server computing system 12 comprises a SaaS server, each client computing system 16, in particular the client application(s) 16A, comprises a SaaS client. Typically, the SaaS client comprises a web browser. The hardware and software components of the client computing system 16, and their configuration, may take any suitable conventional form. Typically, each client computing system 16 comprises a visual display unit (VDU) (not shown) and/or other means for rendering data (e.g. in a web page) that has been provided by the server computing system 12 to a user (not shown). Each client computer system 12 may comprise any convention type of computing device (e.g. desktop computer, laptop computer, mobile computing device, smartphone and so on).

The gateway computing system 14 typically comprises one or more computer executing, in use, one or more computer program, typically comprising one or more gateway (software) application or process 14A, and is configured to provide a gateway (which may alternatively be referred to as a layer or interface) between the server computing system 12 and the client computing systems 16 via the network 18 as is described in more detail hereinafter. In preferred embodiments, the gateway computing system 14, in particular the gateway application 14A, is configured to serve as a reverse proxy between the server computing system 12 and the client computing systems 16, and may be referred to as a reverse proxy server. In typical embodiments, the gateway computing system 14 is separate from the server computing system 12 and the client computing systems 16, e.g. the gateway application(s) 14A is hosted on computer(s) that is separate from the computers that host the server application(s) 12A and client applications 16A. As such, the gateway computing system 14 may communicate with the server computing system 12 and the client computing systems 16 via the network 18, typically via the internet. In alternative embodiments, the gateway computing system 14 may be incorporated into the server computing system 12, e.g. the gateway application(s) 14A may be hosted on computer(s) that are the same as, or are connected to the same local network (e.g. LAN) as, the computer(s) that host the server application(s) 12A. As such, the gateway computer system 14 may communicate with the client computer systems 16 via the network 18, but with the server computing system 12 via a local network and/or program interface. Alternatively still,, the gateway computing system 14 may be incorporated into any one of the client computing systems 16, e.g. the gateway application(s) 14A may be hosted on computer(s) that are the same as, or are connected to the same local network (e.g. LAN) as, the computer(s) that host the client application(s) 16A. As such, the gateway computer system 14 may communicate with the server computer system 12 and other client systems 16 via the network 18, but with the hosting client system 16 via a local network and/or program interface.

Alternatively, the gateway computing system 14 may be distributed in the system 10 in any convenient manner.

In preferred embodiments, the server application(s) 12A comprises a multi-tenancy application, or multi-tenancy server (typically a multi-tenancy SaaS server), wherein each client computing system 16, in particular the respective client application 16A, is a tenant (typically a SaaS tenant). As such, the gateway computing system 14 may be referred to as a multi-tenant gateway, or multi-tenant reverse proxy server.

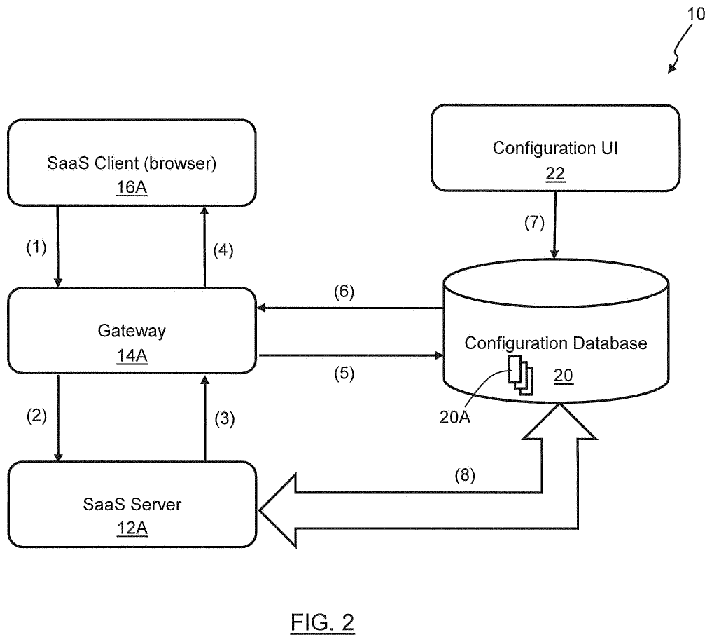

FIG. 2 is a block diagram illustrating the redaction system 10 and its operation. FIG. 2 illustrates the system 10 in the context of a single client 16A, although as described above the system 10 typically includes multiple clients 16, 16A, and the system 10 may interact with each client 16, 16A in a corresponding manner. In the preferred embodiment of FIG. 2, the client application 16A comprises a SaaS client, typically comprising a web browser, and the server application 12A comprises a SaaS server. In alternative embodiments, the client(s) 16A and server 12A may support a generic client-server model and need not necessarily support the provision of SaaS.

In preferred embodiments, the client 16A, server 12A and gateway 14A communicate with each other (as required) using a request-response protocol whereby the client 16A makes a request for resource(s) provided by the server 12A, and the server 12A provides a response (which can be referred to as a response message) that comprises content relating to the request. As is described in more detail hereinafter, request-response communication between the client 16A and server 12A is effected via the gateway 14A. The content may take any conventional form(s), for example comprising one or more instance of any one or more of: text (e.g. alphanumeric string(s)), link(s) (e.g. hyperlink(s), link(s) to downloadable resources (e.g. computer files)), computer file(s) (e.g. image file(s), video file(s), audio file(s), text file(s)), URI(s), URL(s), and/or any other data (e.g. code(s)) or digital content. The content, in particular the element(s) of the content that are rendered to the user, may be referred to as, or may comprise, the payload of the response. The content may be provided in any conventional format that allows the client 16A to render the content to the user. In typical embodiments where the client 16A comprises a web browser, the content is provided in a format (e.g. JSON, XML or HTML) that allows the client 16A to render the content to the user in the form of web page(s).

In typical embodiments, the communications network 18 comprises the internet and so the client 16A, server 12A and gateway 14A (and any supporting software and hardware) communicate with each other (as required) using the internet protocol suite. In the present example, therefore, it is assumed that requests and responses are made using http protocol. It will be understood that in alternative embodiments other protocol(s) may be used for requests and responses, and more generally for communication in the system, as required.

Referring in particular to FIG. 2, the system 10 is configured such that a request (1), sent by the client 16A, for resource(s) provided by the server 12A is received by the gateway 14A. The gateway 14A is configured to send a corresponding request (2) to the server 12A. The system 10 is configured such that a response (3), sent by the server 12A, to the request (2) is received by the gateway 14A. The gateway 14A is configured to send a corresponding response (4) to the requesting client 16A. The preferred gateway 14A therefore may be referred to as a reverse proxy server between the client 16A and server 12A.

The gateway 14A is configured to modify, as required, the content of the response (3) received from the server 12A, and to send the corresponding response (4) to the client 16A with the modified content. In particular, the gateway 14A is configured to modify one or more element of the content of the response (3) that comprises, or relates to, information that the user of the client 16A does not have permission to access. The gateway 14A is configured to modify the, or each, relevant element of the content of the response (3) by redacting the respective element. The reaction may take any suitable form (typically depending on the type of the element being redacted), for example deletion, removal, replacement or masking of data or other elements, and/or blocking or preventing downloading of resources. Deletion or removal may involve deleting or removing the respective element from the response content entirely, or deleting or removing all or part of the payload data of the respective element. Replacing or masking may involve replacing or masking all or part of the payload data of the respective element with default or dummy data. Preferably, the replacement data is of the same type as the payload data being removed or masked. This helps to avoid system errors or crashes. For example, an alphanumeric string is replaced with a dummy or default alphanumeric string, a number is replaced with a corresponding dummy or default number, a date is replaced with a dummy or default date, and so on.

In preferred embodiments, the gateway 14A is configured to selectively redact one or more elements of the response (3). In particular, the gateway 14A may be configured to redact the content of the response (3) in accordance with one or more set of one or more redaction rules. The, or each, set of redaction rules may be stored in a configuration database 20, or any other suitable data storage means. The database 20, or other storage means, may conveniently be part of the gateway computer system 14 (as illustrated in FIG. 1), but may alternatively be provided at any other location that is accessible by the gateway 14A. In preferred embodiments, the gateway 14A is configured to request (5) and receive (6) one or more rule set from the database 20.

The gateway 14A may be configured to use one or more rule set 20A depending on the setting of one or more identifier included in or associated with the response and/or the response content. In preferred embodiments, the response includes or is associated with one or more user-related identifier. A user may be a user who is accessing the server 12A via a client 16A. The user-related identifier may be associated with a session, in particular a login session, that is established between the client 16A and the server 12A (via the gateway 14A) during use, i.e. the session during which the request(s) (1), (2) are made and response(s) (3), (4) are returned. In typical embodiments, the session is an http/https session. Alternatively, a user may be an individual, e.g. employee, in respect of which at least part of the content or payload of the response relates. User-related identifiers may comprise any one or more of: a unique identifier of the user (e.g. the user of the requesting client 16A or the person to whom the relevant data relates); an identifier of an organisation with which the user is associated; an identifier of the type of user (e.g. the user's role or management level); an identifier of the security access level of the user; an identifier of the geographical location of the user, or an identifier of any other attribute relating to the user, e.g. a user group to which the user belongs. Such user-related identifiers may be provided in any convenient manner. For example, the user-related identifier(s) may be included in the request (1) and/or the response (3), e.g. as part of the content or overhead of the request or response, or may be otherwise obtainable from the requesting client 16A or server 12A. Establishing the session typically involves the user inputting login and/or other user credential information at the client 16A. Corresponding user-related identifier(s) can be obtained from one or more aspect of the established session, e.g. from server-side cookie(s), or client-side cookie(s), a session ID, the request URL and/or from overhead associated with the request, response or session. The preferred gateway 14A is configured to determine the setting of the, or each, relevant identifier, typically the, or each, user-related identifier, and to request (5) the, or each, corresponding rule set.

Typically, one or more content identifier is included in or associated with all or part of the content of the response. The content identifier(s) may for example include one or more content identifier for any one or more of: an identifier of a respective part of the content (content item ID); the type of the content of the response (3); a context or other attribute of the response (3); and/or the type of, or unique identifier of, one or more element of the content of the response (3). An employee ID, a Supplier ID and an Invoice ID are non-limiting examples of content identifiers.

The setting of each user-related or content identifier may be determined in any convenient manner, and may for example be included in (or derivable from) the response (3) (e.g. the content and/or overhead of the response (3) and/or included in (or derivable from) the request (1) (e.g. the content and/or overhead of the request (1). In preferred embodiments, the gateway 14A is configured to determine a unique identifier of the, or each, user (e.g. the user that made the request (1) or user(s) to whom the data relates), to request (5) or otherwise obtain the or each rule set associated with the identified user(s), and to redact the content of the response (3) in accordance with those rule set(s). Depending on the embodiment, the unique identifier of the user may be a personal identifier or an account identifier (e.g. in cases where the user has personal login details or account login details for the system), or may be a unique identifier of the client 16A or client computer.

Alternatively, or in addition, the gateway 14A may be configured to use one or more default or standard redaction rule set on the content of all responses (3), or selected responses, for example responses in respect of which another rule set does not exist or cannot be found or identified. Such default or standard rule sets may for example stipulate which element(s) of the content of the response (3) are to be redacted, and preferably how they are to be redacted, depending on the type of the content and/or the type of one or more element of the content. For example, the rule set may stipulate that all elements that comprise links are to be removed, and/or that all elements that are of an unknown type or ID are to be removed or replaced with suitable dummy data.

Accordingly, the database 20, or other storage means, typically stores multiple sets of redaction rules, any one or more of which may be selected for use in redacting the content of any given response (3). Each rule set 20A may be associated with a setting of one or more of the identifiers, typically one or more user-related identifier. For example, one or more respective rule set 20A may be associated with each unique user identifier or other user-related identifier settings. This arrangement allows the gateway 14A to request (5) or to otherwise obtain one or more respective rule set 20A that has been configured for use with any response content associated with the respective identifier setting. For example, for responses (3) associated with one or more given unique user identifier (or given setting of any other user related identifier(s)), the gateway 14A obtains and uses the respective rule set(s) 20A for the given user identifier(s) (or given setting of any other user related identifier(s)). As such, the gateway 14 may redact response content differently depending on the setting of one or more user-related identifiers, e.g. depending on any one or more of: who the user is; where the user is; what organization they belong to; what account they use to access the system; and/or which client or client computer they use to access the system. Such user-related redaction may be performed in respect of one or more user who is accessing the server 12A using a client 16A. As such, the relevant redaction rule set(s) 20A may determine which part(s) of the content or payload are redacted before the redacted content is rendered to the user. Alternatively or in addition, the user-related redaction may be performed in respect of one or more user (or subject, e.g. employee or other person) in respect of which the content or payload to be redacted relates. In cases wherein the content or payload to be redacted contains data relating to more than one user (or subject), depending on the respective redaction rule set(s) 20A, the respective data for each user (or subject) may be redacted differently. For example, if the content (which may for example define a web page) comprises one or more respective data element for a plurality of users (or subjects), then one or more of the respective data element(s) may be redacted differently in respect of each user (or subject) dependent on the respective rule set 20A (or user-related identifier(s)) for each user (or subject).

Advantageously, the or each redaction rule set 20A is configurable. In particular, each rule set 20A may be configurable to change which element(s) of the response content are redacted and/or how they are redacted. To this end, the system 10 may include a configuration user interface 22 to enable an administrator to configure (7) or edit existing rule sets 20A and/or to create new rule sets 20A. As such the redaction that is applied to any given response content may easily be changed during use of the system 10.

In preferred embodiments, the gateway 14 is configured to request (5) or otherwise obtain the relevant rule set(s) in response to receiving each response (3) from the server 12A. This ensures that each response (3) is redacted in accordance with up-to-date rule set(s) 12A.

In typical embodiments, each element of the content of the response (3) is associated with one or more content identifier in the form of one or more content element identifier. The gateway 14A in conjunction with the relevant rule set(s) 20A may use the element identifiers to determine which elements are to be redacted and/or how they are to be redacted. For example, each rule set 20A may contain a list of one more element identifiers and corresponding instructions on how the respective elements are to be redacted. The gateway 14 may match element identifiers that it finds in the response content with element identifiers in the respective rule set(s) 20A to determine how to redact the response content.

In preferred embodiments, the server 12A may provide (8) data to database 20 or gateway 14A indicating or defining the element identifiers used in the content of the response (3) to ensure that the rule sets 20A are compatible or up-to-date with the response content in this respect. The administrator may use such data when configuring or re-configuring rule sets 20A via the configuration UI 22.

The content of the response (3) from the server 12A may be in any conventional format, and may vary from embodiment to embodiment depending on which format(s) are supported by the system. Conveniently, the modified content of the corresponding response (4) uses the same format as the content of the response (3). In typical embodiments, the content of the response (3) is in JSON format, XML format or HTML format. The content typically comprises a data structure or computer file (e.g. a JSON file, XML file, HTML file or file created using another format or mark up language). The file is sent as part of the request (3), which usually also includes overhead (e.g. address(es) or other identifier(s)) to facilitate transmission of the request (3) from the server 12A to the client 16A using the relevant protocol (e.g. http).

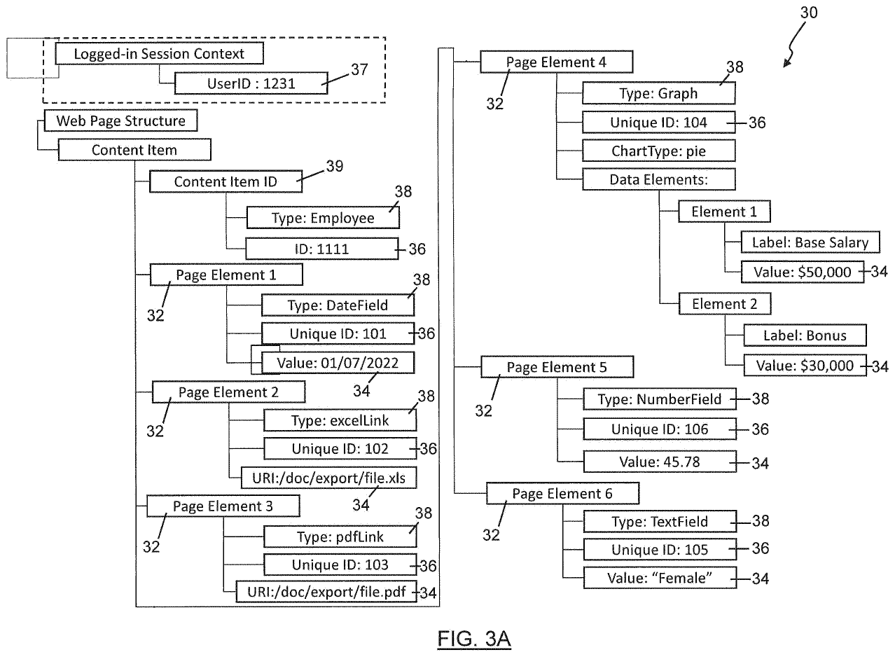

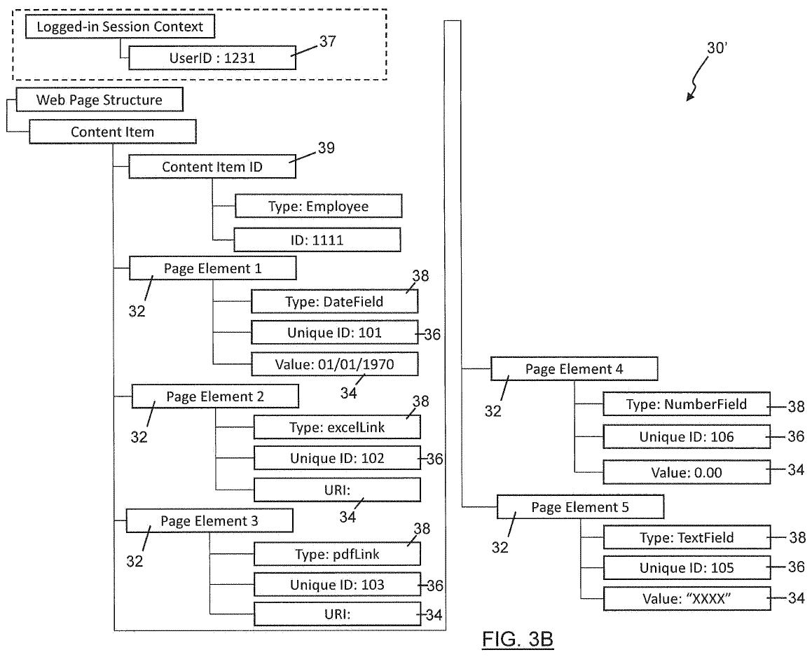

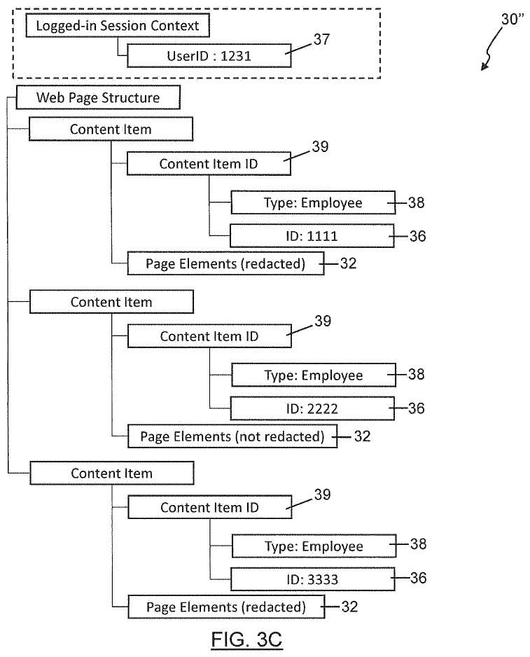

FIG. 3A illustrates, generally indicated as 30, an exemplary instance of the content of a response (3) sent from the server 12A in response to a request (1) from the client 16A, and received by the gateway 14A. The content 30 comprises data compliant with a data format or file format, and which is typically embodied as a computer file or data structure. In the illustrated example, the content 30 defines a web page, including the web page content, which may be rendered to a user by a web browser.

The content 30 comprises at least one but more usually a plurality of elements 32, each element 32 comprising respective data 34. The data 34 may be described as the payload of the respective element 32, and is part of the payload of the response. Typically, the data 34 may be of any one of a plurality of data types. Examples of data types include but are not limited to: text, character string (alphanumeric or otherwise), numerical value, link, resource identifier (e.g. URI or URL), code, date, image, graph, list, grids, button text, rich text area, drill down number, checkbox, file. Examples of links include but are not limited to: links to a file or other resource, hyperlinks, URI links, URL links. Each element 32 typically includes at least one content element identifier 36, 38, which may be of different types, e.g. a unique identifier for the element 32, or an identifier for the type of data 34. In preferred embodiments, each element 32 has a unique element identifier 36 that identifies the respective element 32, and an element data type identifier 38 that identifies the type of data contained in the respective element 32. The element identifiers 36, 38 may be regarded as types of content identifier.

FIG. 3A illustrates a user related identifier 37 that identifies the user (and/or other user related information) for which the response (3) is being provided. Depending on the embodiment, the user identifier 37 may comprise, for example, any one or more of: a personal user identifier, an account identifier; an organization identifier or an identifier of the requesting client 16A. As described above, the user related identifier 37 may be used by the gateway 14 to determine which rule set(s) 20A are to be used to redact the content 30, in particular the data 34. As described above, the user related identifier 37 may be said to be associated with the content 30 in that it is associated with, or included in, the request (1), the response (3) and/or the session established between the client 16A and server 12A (via the gateway 14A) during which the content 30 is requested by and/or provided to (redacted or unredacted as appropriate) the user of the client 16A.

The content 30 may include one or more type of content identifier, which may be referred to as a content item ID 39, that identifies one or more attribute of the content 30 as a whole or of part of the content 30, e.g. identifier(s) of any one or more of: a person, organization, location, security level, information type (e.g. personal information or financial information) associated with the content 30 or part thereof. The respective rule set(s) 20A may stipulate how the content 30 is to be redacted depending on the setting of the content item ID(s) 39, e.g. how the content 30 as a whole is to be redacted or how a respective part of the content 32 is to be redacted, or how the respective elements 32 of the content 30 are to be redacted.

The content 30 may include one or more other identifiers (not shown), for example an identifier for identifying a web page and/or an identifier identifying a field of a web page in respect of which the redaction is to be performed. Any combination of two or more identifiers included in, or otherwise associated with, the content 30 may be used to determine how the content is to be redacted.

The respective data 34 of each element 32 may be at least part of the payload of the content 30, and typically it is this payload that is redacted by the gateway 14A since it is the data 24 that is (unless redacted) made available to the user (e.g. by display in a web page or other user interface). The identifiers 36, 38 (and any other identifiers) may be referred to as overhead or as part of the payload.

The example of FIG. 3A includes the following elements 32 by way of illustration:

Page Element 1 having the unique identifier “101” and data 34 comprising a date (01/07/2022);

Page Element 2 having the unique identifier “102” and data 34 comprising a URI link to an excel file;

Page Element 3 having the unique identifier “103” and data 34 comprising a URI link to a PDF file;

Page Element 4 having the unique identifier “104” and data 34 comprising a graph;

Page Element 5 having the unique identifier “105” and data 34 comprising text (“Female”); and Page Element 6 having the unique identifier “106” and data 34 comprising a number (“45.78”).

Elements 32 may include more than one instance of data 34, as can be seen by way of example from Element 1 and Element 2 of Page Element 4 in FIG. 3.

Typically, the respective unique element identifier 36 is used to determine if the respective element 32, and in particular the data 34 of the respective element 32, is to be redacted. The gateway 14A may use the rule set(s) 20A associated with the content 30 to determine if and/or how it has to redact the respective data element 32. The gateway 34 may use the user identifier 37 associated with the content 30 (which is typically the user identifier 37 associated with the session during which the content 30 is requested) to obtain the respective rule set(s) 20A for redacting the content 30. Alternatively, the gateway 14A may obtain the respective rule set(s) 20A by any other means, e.g. from other overhead included in the content 30 or other overhead included in the response (3). The respective rule set(s) 20A may stipulate how the respective element 32, or respective data 34, is to be redacted. Alternatively, or in addition, the gateway 14A may determine how to redact the respective element, or respective data 34, from the respective element data type identifier 38.

In typical embodiments, the relevant rule set(s) 20A contains a list of one or more element identifier, each identifier being associated with one or more respective instruction on redacting the respective element. The gateway 14A may be configured to match the element identifiers of the content 30 with the element identifiers of the respective rule set(s) 20A in order to determine if and/or how the respective element 32 of the content is to be redacted. In particular, each rule set 20A may contain one or more unique element identifier 36 and a corresponding instruction indicating if the respective element is to be redacting and/or how the respective element is to be redacted. The gateway 14A may be configured to match each unique element identifier 36 of the content 30 with the respective unique element identifier of the respective rule set(s) 20A in order to determine if and/or how the respective element 32 of the content is to be redacted. Each rule set 20A may contain one or more element data type identifier 38 and a corresponding instruction indicating how the respective data type is to be redacted. The gateway 14A may be configured to match each element data type identifier 38 of the content 30 with the respective element data type identifier of the respective rule set(s) 20A in order to determine how the respective element 32 of the content is to be redacted. Optionally, if the gateway 14A finds a unique element identifier 36 in the content 30 and cannot find a match in the respective rule set(s) 20A, it is configured to take default action, e.g. to remove or otherwise redact the unmatched element 32. Alternatively, the gateway 14A may be configured to redact only elements 32 in respect of which a match is found in the respective rule set(s) 20A.

Each rule set 20A may include one or more respective instruction on redacting the respective element(s) associated with one or more combination of two or more identifiers, e.g. any two or more of, or any two or more instances of: a user-related identifier, an element data type identifier, a unique element identifier, a content item ID or other content identifier.

Each rule set 20A may include or be associated with a respective rule set identifier, e.g. a unique rule set identifier. In preferred embodiments, the gateway 14 is configured to match the, or each, user-related identifier 37 with respective rule set identifier(s) in order to determine which rule set(s) 20A are used to redact the respective content 30. For example, in cases where the user-related identifier comprises a unique user identifier, the gateway 14A obtains one or more rule set 12A having a rule set identifier that matches the unique user identifier. This arrangement allows different rule set(s) 12A to be used for each user. The content 30 may include or be associated with one or more other user related identifiers, for example an identifier of any one or more of: geographical location; user group; organisation; security level.

In preferred embodiments where there is a correspondence between user related identifier(s) and rule set(s), e.g. one or more rule set 20A is assigned to one or more user identifier and/or other user related identifier, each rule set 20A may include one or more rule stipulating how the content 30 is to be redacted depending on one or more attribute that is associated with the content 30 but which is not, or may not be, identified by or identifiable by any element of the content 30, e.g. not associated with any content identifier. For example, the attribute may be a geographical location of, or identity of, a person or organization to which the content 30 relates, or a security level associated with the content 30 or some other context relating to the content 30. In response to detecting such a rule, the gateway 14A is configured to interrogate the server 12A to determine the respective attribute from the server 12A, e.g. to determine the respective setting or value of the attribute, and to redact, or not redact, the content 30 accordingly. For example a rule set 20A for a given user may include a rule stipulating that the user is not allowed access to content that relates to a particular organisation, or a particular location or a particular security level. For each response (3) received by the gateway 14A relating to the user, the gateway 14A interrogates the server 12A to establish if the content 30 relates to the sanctioned organization, location, security level (or other attribute(s) as applicable), and either redacts or does not redact the content 30 accordingly. The content 30 may be redacted in full or in part (as described above) as required and as stipulated by the rule set.

The gateway 14A may be configured to use one or more default or standard redaction rule set on the content of responses (3) in respect of which another rule set does not exist or cannot be found or identified, e.g. if the content 30 does not have a user identifier, or if there are no (dedicated or bespoke) rule sets 20A associated with the user identifier or other relevant identifier of the content 20. Such default or standard rule sets may for example stipulate which element(s) of the content of the response (3) are to be redacted, and preferably how they are to be redacted. The default redaction rules make take any suitable form, and may be set by an administrator. For example default redaction rules may include redacting all elements of the content, or only selected elements depending on the data type element identifier and/or the unique element identifier and/or any other element identifier, or, depending on the type of the content. For example, the default rule set may stipulate that all elements that comprise links are to be removed, and/or that all elements that are of an unknown type or ID are to be removed or replaced with suitable dummy data.

FIG. 3B shows a redacted version 30′ of the content 30 of FIG. 3A. For Page Element 1, the gateway 14A has redacted the respective data 34 by replacing the actual date provided by the server 12A with a dummy date, e.g. “01/01/1970” (which in this example means that the client 16A renders the dummy date to the user). For Page Element 2, the gateway 14A has redacted the respective data 34 by deleting the link (which in this example prevents the client 16A from accessing the Excel file). For Page Element 3, the gateway 14A has redacted the respective data 34 by deleting the link (which in this example prevents the client 16A from accessing the PDF file). For Page Element 4, the gateway 14A has redacted the respective element 32 by removing element 32 from the content 30 (which in this example prevents the graph from being received by the client 16 or rendered to the user). For Page Element 5, the gateway 14A has redacted the respective data 34 by replacing the actual text provided by the server 12A with dummy or default text, e.g. “XXXXXX” (which in this example means that the client 16A renders the dummy or default text to the user). For Page Element 6, the gateway 14A has redacted the respective data 34 by replacing the actual number provided by the server 12A with a dummy or default number, e.g. “0.00” (which in this example means that the client 16A renders the dummy or default number to the user). As can be seen from the example of FIG. 3B, when data 34 is redacted by way of replacement, it is preferred to use replacement data of the same data type as the replaced data (e.g. as indicated by the respective element data type identifier 38).

FIG. 3C shows another example of content 30″ illustrating a data structure (a web page structure in the illustrated example) comprising a plurality of content items each having a respective content item ID 39. Each content item may include one or more respective content element 32. In the example of FIG. 3C, each content item relates to a respective person, in particular an employee, by way of example only. Each content item may be redacted differently depending on the content item ID. For example, the redaction rules 20A for the content 30″ may include respective rules for the respective parts (i.e. content items) of the content 30″ depending on the respective content item ID. The rules may additionally indicate how the respective content elements 32 are redacted, as described above. In the example of FIG. 3C the respective content item ID 39 may be said to comprise a user-related identifier associated with the respective employee or other respective person. As described above one or more respective rules 20A may be associated with each content item ID 39, and therefore with the respective employee or other person. The content 30″ may therefore be redacted differently for each employee, or other person, depending on the respective content ID, or user-related identifier, which may depend on one or more attribute of the employee/person as described above.

In use, the client 16A accesses the server 12A via the gateway 14A. Typically, the client 16A initiates access using a URI or URL for the gateway 14A, e.g. a URI or URL requesting a resource provided by the server 12A via the gateway 14A. The gateway 14A redirects the request to the server 12A. The server's response, e.g. comprising a URI or URL for a login page or homepage provided by the server 12A is sent to the gateway 14A, which redirects it to the requesting client 16A. More generally, requests (1) from the client 16A to access resources provided by the server 12A are sent to gateway 14A. The gateway 14A redirects the requests (1) to the server 12A. Typically, this redirection involves replacing or modifying one or more URI or URL associated with the request (1) so that the corresponding request (2) can be sent to the server 12A. In particular, the request (1) received from the client 16A may comprise one or more URI or URL that includes an identifier for the gateway 14A such the request (1) is sent to the gateway 14A. The gateway 14A modifies the, or each, URI or URL by replacing the identifier with an identifier for the server 12A and then forwards the corresponding request (2) to the server 12A with the modified URI(s) or URL(s).

When the redirected request (2) is received by the server 12A, the server 12A may handle the request (2) as a request from a client. Accordingly, when the server 12A sends the response (3) to the request (2), the response (3) is sent to the gateway 14A. Conveniently, this happens by default since the request (2) identifies the gateway 14A as the requesting entity (typically from the URL of the request (2)) and so configures the response (3) to be sent to the gateway 14A.

When the gateway 14A receives the response (3), it redacts the content of the response (3) as required. This may involve parsing the content 30 to determine the content identifier(s), e.g. user identifier, (or otherwise determining the content identifier (s)) and then obtaining (5), (6) the respective redacting rule set(s) 20A associated with the content identifier(s). Alternatively, or in addition, a standard or default redaction rule set(s) 20A may be used to redact the content of the response (3). In any case, the gateway 14A may parse the content 30 to determine the values or settings of the relevant element identifiers in order to determine, typically in conjunction with the relevant redaction rules, how the content is to be redacted, which typically involves determining which element(s) of the content are to be redacted and/or how they are to be redacted.

Once the content 30 has been redacted, the gateway 14A sends the corresponding response (4) to the client 16A with the redacted content 30. Typically, the gateway 14A redirects the response to the client 16A by replacing or modifying one or more URI or URL associated with the response (3) so that the corresponding response (4) is sent to the client 12A. In particular, the response (3) received from the server 12A may comprise one or more URI or URL that includes an identifier for the gateway 14A such the response (3) is sent from the server 12A to the gateway 14A. The gateway 14A may modify the, or each, URI or URL by replacing the identifier with an identifier for the client 16A and then forwards the corresponding response (4) to the client 16A with the modified, or replaced, URI(s) or URL(s).

The response (3) may include one or more other URI, URL or other link (which may for example be included in the content 30 (e.g. as part of an element 32) or elsewhere in the request (3) (e.g. as part of overhead)) that points to, or otherwise identifies, a location or resource at the server 12A (typically in addition to the URL or URI that directs the response (3) to the gateway 14A). The gateway 14A may also modify or replace any such URI, URL or other link such that the modified or replaced URI, URL or link points to, or identifies, the gateway 14A rather than the server 12A. As such, when the client 16A uses the modified URI, URL or link, the client 16A, in particular any corresponding request(s) (1) from the client 16A, is directed to the gateway 14A rather than to the server 12A.

Typically, modification of the response (3) involves URI replacement to change any URI's in the response content and overhead so that they point back to the gateway 14A and not to the server 12A. For example, the response (3) from the server 12A may contain multiple URIs containing or identifying the server 12A. These URIs should all be modified (unless they are redacted) to contain corresponding gateway URIs instead of server URIs. This process causes subsequent request and responses between the client 16A and server 12A to be channelled via the gateway 14A. As a result, the indirect interaction between the client 16A and the server 12A via the gateway 14A appears seamless to the user.

In preferred embodiments the system 10 is configured to allow the user, via the client 16A and in respect of content 30 rendered to the user by the client 16A, to input value(s) for the data 34 of one or more element 32 irrespective of whether or not the data 34 was redacted before the content 30 was rendered to the user. Any such data values input by the user are sent from the client 16A to the server 12A via the gateway 14A (e.g. in the form of a request) and may be stored in the applicable database or other storage means. Typically, the content 30 is rendered as a web page or other user interface that includes one or more data entry field for the respective data 34. Using the client 16A the user may enter value(s) into the relevant data entry field whereupon the entered value(s) are communicated to the service 12A. Accordingly, the preferred system 10 supports ability to transact on redacted data, i.e. even though the data is redacted the user can still overwrite it and submit the new value to the data store. Preferred embodiments support the ability for data in a rendered HTML form, or other user interface, to be redacted, and allowing data input by the user into the redacted form, or redacted interface, to posted, or stored, by the server 12A in its normal manner.

It will be understood that systems and methods embodying the invention may be implemented in software, firmware, hardware, or a combination thereof. For example, the processes described herein may be implemented in software, as one or more executable program, and executed by one or more special or general purpose digital computer(s) or processor(s), such as a personal computer (PC; IBM-compatible, Apple-compatible, or otherwise), mobile computing device, smart phone, personal digital assistant, workstation, minicomputer, or mainframe computer. Process steps may be implemented by a processor or computer in which corresponding software modules reside or partially reside. In particular, the server 12A, the gateway 14A and the clients 16A each may comprise one or more computer program for performing the methods described herein, and may include or have access to one or more data storage device for storing any necessary code and/or data, and may be executed on any conventional computer(s) or other processor(s).

Optionally, embodiments of the invention may be implemented using PaaS (platform as a service), e.g. using Microsoft Azure or Amazon Web Services (AWS), or IaaS (infrastructure as a server), e.g. using Microsoft Azure, Google Cloud or AWS).

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s). The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

The invention is not limited to the embodiment(s) described herein but can be amended or modified without departing from the scope of the present invention.

What is claimed is:

1. A method of redacting server responses in a client-server computing system in which a server and a client communicate via a gateway, the method comprising:
receiving, at said gateway, a response from said server, wherein said response includes content associated with at least one content identifier;
identifying at least one redaction rule for use in redacting said response, wherein at least one of said at least one redaction rule is associated with at least one of said at least one content identifier;
selectively redacting at least part of said content in accordance with the, or each, identified redaction rule associated with the, or each, content identifier;
sending a corresponding response to said client, said corresponding response comprising the redacted content.

2. The method of claim 1, wherein said content comprises at least one content element, and said at least one content identifier comprises at least one content element identifier, wherein at least one of said at least one content element identifier is associated with at least one of said at least one redaction rule, said redacting involving redacting one or more of said at least one content element in accordance with the, or each, redaction rule associated with the, or each, respective content element identifier, the, or each, respective content element identifier typically also being associated with said one or more of said at least one content element, and wherein said corresponding response comprises the one or more redacted content element, and wherein said redacting optionally involves removing the respective content element from the response content, and/or wherein said at least one content element optionally comprises data, and said redacting involves deleting said data, and/or replacing said data with alternative data, wherein said alternative data is preferably of the same type as the replaced data.

3. The method of claim 2, wherein said at least one content element identifier comprises at least one unique content element identifier that uniquely identifies the respective content element, and wherein the, or each, respective redaction rule indicates if said respective content element is to be redacted and/or how said respective content element is to be redacted and/or wherein said at least one content element identifier comprises at least one data type identifier that identifies a type of data contained in the respective content element, and wherein said redacting involves redacting the respective content element depending on the type of data identified by the, or each, respective data type identifier.

4. (canceled)

5. The method of claim 1, wherein at least one content identifier is included in, or associated with, said content, and wherein said identifying at least one redaction rule involves identifying said at least one redaction rule depending on said at least one content identifier.

6. The method of claim 1, wherein said response includes or is associated with one or more user identifier identifying a user of said client and/or one or more user in respect of which the content relates, and/or one or more user-related identifier identifying a respective attribute of said the, or each, user, said one or more user-related identifiers optionally comprising any one or more of: a unique identifier of the user; an identifier of an organisation or group with which the user is associated; an identifier of the type of user; an identifier of a security access level of the user; an identifier of a geographical location of the user, or an identifier of any other attribute relating to the user, and wherein, optionally, the method includes obtaining said user identifier and/or said one or more user-related identifier from said response, or from a request sent by said client to said gateway, or from said client, or from said server.

7. (canceled)

8. (canceled)

9. The method of claim 6, wherein the user identifier and/or said one or more user-related identifier is associated with a session, for example a login session, established between the client and the server via the gateway, wherein the method optionally includes obtaining said user identifier and/or said one or more user-related identifier from one or more aspect of said session, wherein said one or more aspect may comprise any one or more of: one or more server-side cookie; one or more client-side cookie, a session ID, a request URL and/or from overhead associated with the response, the session and/or a request sent by said client to said gateway.

10. (canceled)

11. The method of claim 6, wherein said identifying at least one redaction rule involves identifying said at least one redaction rule depending on said user identifier and/or said one or more user-related identifier.

12. The method of claim 6, wherein said content includes one or more respective part or respective element(s) relating to a plurality of users, and wherein the respective part or element is redacted depending on the respective user-related identifier(s) and/or respective redaction rule set(s) associated with the respective user, and wherein each user may be a person, e.g. an employee.

13. The method of claim 1, wherein said redacting involves removing said at least part of said content, or replacing said at least part of said content with alternative content.

14. (canceled)

15. (canceled)

16. (canceled)

17. The method of claim 2, wherein said at least one content element comprises a link to a resource, a unique resource identifier and/or a unique resource locator, and wherein said redacting involves removing said link, said unique resource identifier and/or said unique resource locator, and/or wherein said at least one content element comprises a link to a resource, a unique resource identifier and/or a unique resource locator that identifies or otherwise relates to said server, the method further including replacing or modifying said link, said unique resource identifier and/or said unique resource locator to identify or otherwise relate to said gateway.

18. (canceled)

19. The method of claim 1, wherein said identifying involves identifying at least one default redaction rule for use in redacting said response.

20. The method of claim 1, wherein said identifying involves, in response to failing to identify at least one redaction rule associated with said response or said content, using at least one default redaction rule to redact said response or content.

21. The method of claim 2, wherein said identifying involves, in response to failing to identify at least one redaction rule for at least one of said at least one element identifier, using at least one default redaction rule to redact said at least one of said at least one element identifier.

22. The method of claim 11, wherein said identifying involves, in response to failing to identify said at least one redaction rule depending on said user identifier and/or said one or more user-related identifier, using at least one default redaction rule to redact said response or content.

23. The method of claim 1, wherein said at least one redaction rule comprises at least one redaction rule that is not associated with said at least one content identifier, and wherein said method includes, in respect of at least one redaction rule that is not associated with said at least one content identifier, obtaining from said server information relating to at least one redaction rule that is not associated with said at least one content identifier, and, depending on said information received from said server, selectively redacting at least part of said response or at least part of said content in accordance with said at least one redaction rule that is not associated with said at least one content identifier.

24. The method of claim 1, wherein said at least one redaction rule comprises at least one redaction rule that is associated with an attribute of said content, and wherein said method includes, in respect of at least one redaction rule that is associated with said attribute, obtaining from said server information relating to said attribute, and, depending on said information received from said server, selectively redacting at least part of said response or at least part of said content in accordance with said at least one redaction rule associated with said attribute, and wherein the attribute may be a geographical location of, or identity of, a person or organization to which the content relates, or a security level associated with the content, or an information type of the content.

25. (canceled)

26. The method of claim 1, wherein said response relates to a request sent by said client to said gateway, the method including, receiving sad request at said gateway, forwarding said request from said gateway to said server, and receiving said response at said gateway.

27. The method of claim 1, wherein said content comprises at least one content item, each content item comprising at least one content element, wherein said at least one content identifier comprises at least one content item identifier, wherein at least one of said at least one content item identifier is associated with at least one of said at least one redaction rule, said redacting involving redacting one or more of said at least one content item in accordance with the, or each, redaction rule associated with the, or each, respective content item identifier, the, or each, respective content item identifier typically also being associated with said one or more of said at least one content item, and wherein said corresponding response comprises the one or more redacted content item, and wherein, optionally, one or more of said at least one content item relates to a respective person, and wherein the or each respective redaction rule for the respective content item may be determined by or associated with one or more attribute associated with the respective person and/or one or more user identifier or user-related identifier associated with the respective person, and wherein the or each attribute may be any one or more of: an organisation or group with which the person is associated; the type of person; a security access level of the person; a geographical location of the person.

28. (canceled)

29. The method of claim 1, including rendering a web page or other user interface at said client, said web page or other user interface including said redacted content, and wherein the method optionally includes receiving at said client input data in respect of a redacted part of said redacted content, and communicating said input data to said server, and wherein, optionally, said web page or other user interface comprises one or more element that is redacted, the method including receiving input data at said client in respect of at least one redacted element, and communicating the input data to said server.

30. (canceled)

31. (canceled)

32. A client-server computing system comprising a server, at least one client and a gateway, said server and said at least one client being in communication with each other via said gateway,
the gateway being configured to receive, a response from said server relating to a request from any one of said at least at least one client, wherein said response includes content associated with at least one content identifier,
the gateway being configured to identify at least one redaction rule for use in redacting said response, wherein at least one of said at least one redaction rule is associated with at least one of said at least one content identifier;
the gateway being configured to selectively redact at least part of said content in accordance with the, or each, identified redaction rule associated with the, or each, content identifier;
the gateway being configured to send a corresponding response to the requesting client, said corresponding response comprising the redacted content.

33. (canceled)
